(19) United States
(12) Patent Application Publication
(10) Pub. No.: US 2012/0074036 A1
(43) Pub. Date: Mar. 29, 2012

(54) FLAME-RETARDANT IMPACT-MODIFIED BATTERY BOXES BASED ON POLYCARBONATE II

(75) Inventors: Thomas ECKEL, Dormagen (DE); Ulrich GROSSER, Kuerten (DE); Claus RÜDIGER, Krefeld (DE); Achim FELDERMANN, Duesseldorf (DE)

(73) Assignee: BAYER MATERIALSCIENCE AG, LEVERKUSEN (DE)

(21) Appl. No.: 13/239,489

(22) Filed: Sep. 22, 2011

(30) Foreign Application Priority Data
Sep. 24, 2010 (DE) 102010041388.7

(51) Int. Cl. B65D 85/88; B29C 51/08; C08K 5/521

(52) U.S. Cl. 206/703; 524/127; 264/328.1; 264/320

(57) ABSTRACT

The present invention relates to battery boxes comprising flame-retardant compositions comprising A) linear and/or branched aromatic polycarbonate and/or aromatic polyester carbonate, B) at least one graft polymer, C) one or more phosphorus compounds, D) optionally one or more antidripping agents, optionally E) thermoplastic vinyl (co)polymer (E.1) and/or polyalkylene terephthalate (E.2), and F) optionally one or more further additives, wherein the composition is preferably free from rubber-free polyalkyl(alkyl)acrylate.

### CROSS REFERENCE TO RELATED APPLICATIONS

This application claims priority to German Patent Application 10 2010 041388.7 filed Sep. 24, 2010, the content of which is hereby incorporated by reference in its entirety.

### BACKGROUND

1. Field of the Invention

The present invention relates to flame-retardant impact-modified battery boxes based on polycarbonate, which contain a graft polymer containing a butadiene or acrylate rubber and a phosphorus-containing flame retardant and which have good impact resistance at low temperatures combined with high weld line strength as well as good flame resistance and excellent chemical resistance. The present invention also relates to the use of the polycarbonate compositions according to the invention to produce battery boxes.

2. Description of Related Art

EP 0 363 608 describes polymer mixtures consisting of aromatic polycarbonate, styrene-containing copolymer or graft copolymer and oligomeric phosphates as flame retardant additives. For certain areas of application the mechanical properties at low application temperatures, in particular the weld line strength and flow characteristics, are not adequate.

EP 0 704 488 describes moulding compositions consisting of aromatic polycarbonate, styrene-containing copolymers and graft polymers with a special graft base in specific proportions. These moulding compositions can optionally be rendered flame resistant with phosphorus compounds. These moulding compositions have very good notched impact resistance, but the flow characteristics, flame proofing and chemical resistance are not adequate for certain applications.

EP 747 424 describes thermoplastic resins containing phosphate compounds with a molecular weight of 500 to 2000 and phosphate compounds with a molecular weight of 2300 to 11,000 as flame retardants, a large number of thermoplastic resins being listed. The high molecular weights of the phosphorus compounds significantly compromise the flow characteristics of the moulding compositions.

EP 754 531 describes reinforced PC/ABS moulding compositions which are suitable for precision parts. Oligophosphates of the BPA type are used inter alia as flame retardants. The high filler contents have a very disadvantageous effect on the mechanical properties, particularly at low application temperatures, and on the flow characteristics.

EP 755 977 describes polymer mixtures consisting of aromatic polycarbonate, graft copolymer with a rubber content of <25% and oligomeric phosphates in a content of <8%. The limited content of flame retardants means that the flow characteristics and flame resistance are not adequate. Moreover, no reference is made to the desired good impact resistance at low application temperatures.

EP 1 003 809 describes PC/ABS moulding compositions containing oligomeric phosphorus compounds and graft polymers consisting of a graft base with a specific particle size. These moulding compositions are characterised by good mechanical properties, particularly also under elevated elasticity loading. Their flow characteristics and flame resistance are not adequate for certain areas of application.

EP 0 983 315 describes moulding compositions consisting of aromatic polycarbonate, graft polymer and a combined flame retardant comprising a monomeric and an oligomeric phosphorus compound. These moulding compositions have high heat resistance and excellent mechanical properties (notched impact resistance and weld line strength), but the flow characteristics and flame resistance, particularly in the case of mouldings with low wall thicknesses, are not adequate.

EP 1 165 680 describes flame-retardant PC/ABS moulding compositions having good mechanical properties (tensile strength, weld line strength), which contain oligomeric phosphates of a defined chain length. The chosen quantity ranges for flame retardants and graft polymer are very broad. For that reason the combination of properties according to the invention, comprising good mechanical properties at low application temperatures and good flame resistance, is not described.

EP-A 635547 discloses flame-retardant polycarbonate compositions containing polycarbonate, a copolymer gel, an impact modifier based on acrylate or diene rubber, a flame retardant such as for example oligophosphate and optionally an impact modifier having a graft base consisting of diene rubber, acrylate rubber or EPDM rubber. However, EP-A 635547 does not disclose battery boxes having the combination of properties according to the invention, comprising good impact resistance at low temperatures combined with high weld line strength as well as good flame resistance and excellent chemical resistance.

However, none of the documents cited describes battery boxes having the properties according to the invention or the use of the compositions according to the invention for the production of battery boxes. Furthermore, with PC moulding compositions containing silicone-based graft polymers as the impact modifier, it has been found that the weld line strength often does not reach the technically required level.

### SUMMARY

An object of the present invention was therefore to provide polycarbonate compositions for the production of battery boxes and the battery boxes themselves, which have good impact resistance at low temperatures combined with high weld line strength as well as good flame resistance and excellent chemical resistance, battery boxes within the meaning of the present invention also encompassing boxes for static and mobile rechargeable power sources such as rechargeable batteries and capacitors.

Surprisingly it was found that battery boxes based on polycarbonate compositions comprising
A) 70.0 to 90.0 parts by weight, preferably 75.0 to 88.0 parts by weight, particularly preferably 77.0 to 85.0 parts by weight (relative to the sum of parts by weight of components A+B+C) of linear and/or branched aromatic polycarbonate and/or aromatic polyester carbonate,
B) 6.0 to 15.0 parts by weight, preferably 7.0 to 13.0 parts by weight, particularly preferably 9.0 to 11.0 parts by weight (relative to the sum of parts by weight of components A+B+C) of at least one graft polymer comprising
   B.1) 5 to 95, preferably 30 to 80 parts by weight of a mixture of
      B.1.1) 50 to 95 parts by weight of styrene, α-methylstyrene, methyl ring-substituted styrene, C₁-C₈ alkyl methacrylate, in particular methyl methacrylate, C₁-C₈ alkyl acrylate, in particular methyl acrylate, or mixtures of these compounds, and
      B.1.2) 5 to 50 parts by weight of acrylonitrile, methacrylonitrile, C₁-C₈ alkyl methacrylates, in particular methyl methacrylate, C₁-C₈ alkyl acrylate, in particular methyl acrylate, maleic anhydride, C₁-C₄ alkyl or phenyl N-substituted maleinimides or mixtures of these compounds, on
   B.2) 5 to 95, preferably 20 to 70 parts by weight of a rubber-containing graft base based on butadiene or acrylate,
C) 2.0 to 15.0 parts by weight, preferably 3.0 to 13.0 parts by weight, particularly preferably 4.0 to 11.0 parts by weight (relative to the sum of parts by weight of components A+B+C) of phosphorus compounds selected from the groups of monomeric and oligomeric phosphates and phosphonates, phosphonate amines, phosphazenes and phosphinates, wherein mixtures of several components selected from one or more of these groups can also be used as flame retardants,
D) 0 to 3.0 parts by weight, preferably 0.01 to 1.00 parts by weight, particularly preferably 0.1 to 0.6 parts by weight (relative to the sum of parts by weight of components A+B+C) of antidripping agents,
E) 0 to 3.0 parts by weight, preferably 0 to 1.0 parts by weight (relative to the sum of parts by weight of components A+B+C) of thermoplastic vinyl (co)polymer (E.1) and/or polyalkylene terephthalate (E.2), the composition particularly preferably being free from thermoplastic vinyl (co)polymers (E.1) and/or polyalkylene terephthalates (E.2), and
F) 0 to 20.0 parts by weight, preferably 0.1 to 10.0 parts by weight, particularly preferably 0.2 to 5.0 parts by weight (relative to the sum of parts by weight of components A+B+C) of further additives,
   wherein the compositions are preferably free from rubber-free polyalkyl(alkyl)acrylate and wherein all stated parts by weight in the present application are standardised such that the sum of parts by weight of components A+B+C in the composition is 100. Compositions as described in many embodiments have a desired range of properties as described herein.

### BRIEF DESCRIPTION OF THE DRAWINGS

FIGS. 1 and 2 depict examples of battery boxes according to the invention.

FIG. 1A shows a battery box for flat battery cells with a gap between the insertion slots for the flat cells, in which a coolant can be placed or in which a coolant circulates.

FIG. 1B shows a top view of the battery box for flat battery cells.

FIG. 1C shows a cross-sectional view (cross-section AA) through the battery box for flat battery cells.

FIG. 2A shows a battery box for cylindrical battery cells with a gap between the insertion slots for the cylindrical cells, in which a coolant can be placed or in which a coolant circulates.

FIG. 2B shows a top view of the battery box for cylindrical battery cells.

FIG. 2C shows a cross-sectional view (cross-section DD) through the battery box for cylindrical battery cells.

### DETAILED DESCRIPTION OF A PREFERRED EMBODIMENT

### Component A

Aromatic polycarbonates and/or aromatic polyester carbonates according to component A which are suitable according to the invention are known from the literature or can be produced by methods known from the literature (regarding the production of aromatic polycarbonates see for example Schnell, “Chemistry and Physics of Polycarbonates”, Interscience Publishers, 1964 and DE-AS 1 495 626, DE-A 2 232 877, DE-A 2 703 376, DE-A 2 714 544, DE-A 3 000 610, DE-A 3 832 396; regarding the production of aromatic polyester carbonates see for example DE-A 3 077 934).

Aromatic polycarbonates are produced for example by reacting diphenols with carbonic acid halides, preferably phosgene, and/or with aromatic dicarboxylic acid dihalides, preferably benzene dicarboxylic acid dihalides, by the interfacial polycondensation process, optionally using chain terminators, for example monophenols, and optionally using trifunctional or higher-functional branching agents, for example triphenols or tetraphenols. Production via a melt polymerisation process by reacting diphenols with diphenyl carbonate, for example, is also possible.

Diphenols for producing the aromatic polycarbonates and/or aromatic polyester carbonates are preferably those of formula (I)

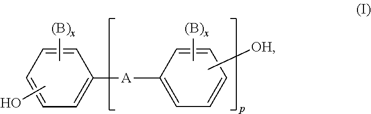

in which
A is a single bond, C₁ to C₅ alkylene, C₂ to C₅ alkylidene, C₅ to C₆ cycloalkylidene, —O—, —SO—, —CO—, —S—, —SO₂—, C₆ to C₁₂ arylene, to which further aromatic optionally heteroatom-containing rings can be fused,
   a radical of formula (II) or (III)

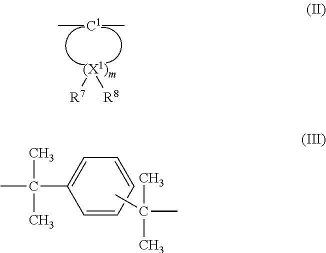

B is in each case C₁ to C₁₂ alkyl, preferably methyl, halogen, preferably chlorine and/or bromine
x is in each case independently 0, 1 or 2,
p is 1 or 0, and
R⁷ and R⁸ can be selected individually for each X¹ and independently of each other denote hydrogen or C₁ to C₆ alkyl, preferably hydrogen, methyl or ethyl,
X¹ denotes carbon and
m denotes a whole number from 4 to 7, preferably 4 or 5, with the proviso that on at least one X¹ atom R⁷ and R⁸ are both alkyl.

Preferred diphenols are hydroquinone, resorcinol, dihydroxydiphenols, bis(hydroxyphenyl) C₁-C₅ alkanes, bis(hydroxyphenyl) C₅-C₆ cycloalkanes, bis(hydroxyphenyl)ethers, bis(hydroxyphenyl) sulfoxides, bis(hydroxyphenyl) ketones, bis(hydroxyphenyl) sulfones and α,α-bis(hydroxyphenyl)diisopropyl benzenes and the ring-brominated and/or ring-chlorinated derivatives thereof.

Particularly preferred diphenols are 4,4′-dihydroxydiphenyl, bisphenol A, 2,4-bis-(4-hydroxyphenyl)-2-methylbutane, 1,1-bis-(4-hydroxyphenyl)cyclohexane, 1,1-bis-(4-hydroxyphenyl)-3.3.5-trimethylcyclohexane, 4,4′-dihydroxydiphenylsulfide, 4,4′-dihydroxydiphenylsulfone and the di- and tetrabrominated or chlorinated derivatives thereof, such as for example 2,2-bis-(3-chloro-4-hydroxyphenyl)propane, 2,2-bis-(3,5-dichloro-4-hydroxyphenyl)propane or 2,2-bis-(3,5-dibromo-4-hydroxyphenyl)propane. 2,2-Bis-(4-hydroxyphenyl)propane (bisphenol A) is preferred in particular.

The diphenols can be used alone or in any combination. The diphenols are known from the literature or can be obtained by methods known from the literature.

Suitable chain terminators for the production of the thermoplastic, aromatic polycarbonates are for example phenol, p-chlorophenol, p-tert-butylphenol or 2,4,6-tribromophenol, but also long-chain alkylphenols, such as 4-[2-(2,4,4-trimethylpentyl)]phenol, 4-(1,3-tetramethylbutyl)phenol according to DE-A 2 842 005 or monoalkylphenol or dialkylphenols having in total 8 to 20 carbon atoms in the alkyl substituents, such as 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally between 0.5 mol % and 10 mol %, relative to the molar sum of the individual diphenols used.

The thermoplastic, aromatic polycarbonates have average weight-average molecular weights (M_{w}, measured for example by GPC, ultracentrifuge or light-scattering measurement) of 10,000 to 200,000 g/mol, preferably 15,000 to 80,000 g/mol, particularly preferably 24,000 to 32,000 g/mol.

The thermoplastic, aromatic polycarbonates can be branched in a known manner, and preferably by the incorporation of 0.05 to 2.00 mol %, relative to the sum of diphenols used, of trifunctional or higher-functional compounds, for example those having three or more phenolic groups.

Both homopolycarbonates and copolycarbonates are suitable. For the production of copolycarbonates according to component A of the invention, 1.0 to 25.0 wt. %, preferably 2.5 to 25.0 wt. %, relative to the total amount of diphenols to be used, of polydiorganosiloxanes having hydroxyaryloxy end groups can also be used. These are known (U.S. Pat. No. 3,419,634) and can be produced by methods known from the literature. The production of copolycarbonates containing polydiorganosiloxanes is described in DE-A 3 334 782.

Preferred polycarbonates in addition to the bisphenol A homopolycarbonates are the copolycarbonates of bisphenol A having up to 15 mol %, relative to the molar sums of diphenols, of other diphenols cited as being preferred or particularly preferred, in particular 2,2-bis(3,5-dibromo-4-hydroxyphenyl)propane.

Aromatic dicarboxylic acid dihalides for the production of aromatic polyester carbonates are preferably the diacid dichlorides of isophthalic acid, terephthalic acid, diphenyl ether-4,4′-dicarboxylic acid and naphthalene-2,6-dicarboxylic acid.

Mixtures of the diacid dichlorides of isophthalic acid and terephthalic acid in the ratio between 1:20 and 20:1 are particularly preferred.

A carbonic acid halide, preferably phosgene, is additionally incorporated in the production of polyester carbonates as a bifunctional acid derivative.

In addition to the monophenols already mentioned, the chloroformic acid esters thereof and the acid chlorides of aromatic monocarboxylic acids, which can optionally be substituted by C₁ to C₂₂ alkyl groups or by halogen atoms, and aliphatic C₂ to C₂₂ monocarboxylic acid chlorides are also suitable as chain terminators for the production of the aromatic polyester carbonates.

The amount of chain terminators in each case is 0.1 to 10.0 mol %, relative in the case of phenolic chain terminators to mols of diphenol and in the case of monocarboxylic acid chloride chain terminators to mols of dicarboxylic acid dichloride.

The aromatic polyester carbonates can also contain incorporated aromatic hydroxycarboxylic acids. The aromatic polyester carbonates can be both linear and branched in a known manner (see DE-A 2 940 024 and DE-A 3 007 934 in this respect).

Trifunctional or higher-functional carboxylic acid chlorides, such as trimeric acid trichloride, cyanuric acid trichloride, 3,3′-,4,4′-benzophenone tetracarboxylic acid tetrachloride, 1,4,5,8-naphthalene tetracarboxylic acid tetrachloride or pyromellitic acid tetrachloride, in amounts from 0.01 to 1.0 mol % (relative to dicarboxylic acid dichlorides used), or trifunctional or higher-functional phenols, such as phloroglucinol, 4,6-dimethyl-2,4,6-tri-(4-hydroxyphenyl) hept-2-ene, 4,6-dimethyl-2,4-6-tri-(4-hydroxyphenyl)heptane, 1,3,5-tri-(4-hydroxyphenyl)benzene, 1,1,1-tri-(4-hydroxyphenyl)ethane, tri-(4-hydroxyphenyl)phenylmethane, 2,2-bis[4,4-bis-(4-hydroxy-phenyl)cyclohexyl]propane, 2,4-bis-(4-hydroxyphenyl isopropyl)phenol, tetra-(4-hydroxyphenyl)methane, 2,6-bis-(2-hydroxy-5-methylbenzyl)-4-methyl phenol, 2-(4-hydroxyphenyl)-2-(2,4-dihydroxyphenyl)propane, tetra-(4-[4-hydroxyphenyl isopropyl]phenoxy)methane, 1,4-bis-[4,4′-dihydroxytriphenyl)methyl]benzene, in amounts from 0.01 to 1.00 mol %, relative to diphenols used, can be used for example as branching agents. Phenolic branching agents can be added with the diphenols, acid chloride branching agents can be introduced together with the acid dichlorides.

The proportion of carbonate structural units in the thermoplastic, aromatic polyester carbonates can vary as required. The proportion of carbonate groups is preferably up to 100 mol %, in particular up to 80 mol %, particularly preferably up to 50 mol %, relative to the sum of ester groups and carbonate groups. Both the ester and the carbonate component of the aromatic polyester carbonates can be present in the form of blocks or be randomly distributed in the polycondensate.

The relative solution viscosity (ηᵣₑₗ) of the aromatic polycarbonates and polyester carbonates is in the range from 1.18 to 1.40, preferably 1.20 to 1.32 (measured in solutions of 0.5 g polycarbonate or polyester carbonate in 100 ml methylene chloride solution at 25° C.).

The thermoplastic, aromatic polycarbonates and polyester carbonates can be used alone or in any combination.

### Component B

The graft polymers B are produced by radical polymerisation, for example by emulsion, suspension, solution or bulk polymerisation, preferably by emulsion polymerisation.

The graft polymers B encompass for example graft polymers with rubber-elastic properties, which are substantially obtainable from at least two of the following monomers: chloroprene, butadiene-1,3, isoprene, styrene, acrylonitrile, ethylene, propylene, vinyl acetate and (meth)acrylic acid esters having 1 to 18 C atoms in the alcohol component; i.e. polymers such as are described for example in “Methoden der Organischen Chemie” (Houben-Weyl), vol. 14/1, Georg Thieme-Verlag, Stuttgart 1961, p. 393-406 and in C. B. Bucknall, “Toughened Plastics”, Appl. Science Publishers, London 1977. Preferred polymers B are partially crosslinked and have gel contents (measured in toluene) of over 20 wt. %, preferably over 40 wt. %, in particular over 60 wt. %.

The gel content is determined at 25° C. in a suitable solvent (M. Hoffmann, H. Krömer, R. Kuhn, Polymeranalytik I and II, Georg Thieme-Verlag, Stuttgart 1977).

Preferred graft polymers B encompass graft polymers comprising:

B.1) 5 to 95, preferably 30 to 80 parts by weight of a mixture of
B.1.1) 50 to 95 parts by weight of styrene, α-methylstyrene, methyl ring-substituted styrene, C₁-C₈ alkyl methacrylate, in particular methyl methacrylate, C₁-C₈ alkyl acrylate, in particular methyl acrylate, or mixtures of these compounds, and
B.1.2) 5 to 50 parts by weight of acrylonitrile, methacrylonitrile, C₁-C₈ alkyl methacrylates, in particular methyl methacrylate, C₁-C₈ alkyl acrylate, in particular methyl acrylate, maleic anhydride, C₁-C₄ alkyl or phenyl N-substituted maleinimides or mixtures of these compounds, on
   B.2) 5 to 95, preferably 20 to 70 parts by weight of a rubber-containing graft base.

The graft base preferably has a glass transition temperature below −10° C.

A graft base based on a polybutadiene rubber is particularly preferred.

The glass transition temperatures are determined by dynamic differential scanning calorimetry (DSC) in accordance with the standard DIN EN 61006 at a heating rate of 10 K/min with definition of T_{g} as the mid-point temperature (tangent method).

Preferred graft polymers B are for example polybutadienes, butadiene/styrene copolymers and acrylate rubbers grafted with styrene and/or acrylonitrile and/or (meth)acrylic acid alkyl esters; i.e. copolymers of the type described in DE-OS 1 694 173 (=U.S. Pat. No. 3,564,077); polybutadienes, butadiene/styrene or butadiene/acrylonitrile copolymers, polyisobutenes or polyisoprenes grafted with acrylic or methacrylic acid alkyl esters, vinyl acetate, acrylonitrile, styrene and/or alkyl styrenes, as described for example in DE-OS 2 348 377 (=U.S. Pat. No. 3,919,353).

Particularly preferred graft polymers B are graft polymers obtainable by the graft reaction of
I. 10 to 70, preferably 15 to 50, in particular 20 to 40 wt. %, relative to the graft product, of at least one (meth)acrylic acid ester or 10 to 70, preferably 15 to 50, in particular 20 to 40 wt. % of a mixture of 10 to 50, preferably 20 to 35 wt. %, relative to the mixture, of acrylonitrile or (meth)acrylic acid ester and 50 to 90, preferably 65 to 80 wt. %, relative to the mixture, of styrene, on
II. 30 to 90, preferably 40 to 85, in particular 50 to 80 wt. %, relative to the graft product, of a butadiene polymer containing at least 50 wt. %, relative to II, of butadiene radicals as the graft base.

The gel content of this graft base II is preferably at least 70 wt. % (measured in toluene), the degree of grafting G 0.15 to 0.55 and the average particle diameter d₅₀ of the graft polymer B is 0.05 to 2, preferably 0.1 to 0.6 μm.

(Meth)acrylic acid esters I are esters of acrylic acid or methacrylic acid and monohydric alcohols having 1 to 18 C atoms. Methacrylic acid methyl ester, ethyl ester and propyl ester are particularly preferred.

In addition to butadiene radicals the graft base II can contain up to 50 wt. %, relative to II, of radicals of other ethylenically unsaturated monomers, such as styrene, acrylonitrile, esters of acrylic or methacrylic acid having 1 to 4 C atoms in the alcohol component (such as methyl acrylate, ethyl acrylate, methyl methacrylate, ethyl methacrylate), vinyl esters and/or vinyl ethers. The preferred graft base II consists of pure polybutadiene.

Since it is known that the graft monomers may not necessarily be completely grafted onto the graft base during the graft reaction, according to the invention, graft polymers B are also understood to include such products which are obtained by polymerisation of the graft monomers in the presence of the graft base.

The moulding compositions according to the invention preferably contain a total proportion of polymer formed from graft monomers or freely added and not chemically bonded to the graft base, for example free SAN, of less than 2.0 wt. %, preferably less than 1.5 wt. % (i.e. from 0.0 to 2.0 wt. %, preferably 0.0 to 1.5 wt. %), relative to the entire moulding composition. If this proportion is increased, the properties according to the invention deteriorate dramatically.

The degree of grafting G denotes the weight ratio of grafted graft monomers to the graft base and is dimensionless.

The average particle size d₅₀ is the diameter above and below which respectively 50 wt. % of the particles lie. It can be determined by ultracentrifuge measurement (W. Scholtan, H. Lange, Kolloid, Z. and Z. Polymere 250 (1972), 782-796).

Other preferred graft polymers B are for example also graft polymers comprising
(a) 20 to 90 wt. %, relative to B, of acrylate rubber as the graft base and
(b) 10 to 80 wt. %, relative to B, of at least one polymerisable, ethylenically unsaturated monomer, the homopolymer or copolymer(s) of which formed in the absence of a) would have a glass transition temperature above 25° C., as graft monomers.

The graft base comprising acrylate rubber has a glass transition temperature of less than −20° C., preferably less than −30° C.

The acrylate rubbers (a) of the polymers B are preferably polymers of acrylic acid alkyl esters, optionally with up to 40 wt. %, relative to (a), of other polymerisable, ethylenically unsaturated monomers. The preferred polymerisable acrylic acid esters include C₁-C₈ alkyl esters, for example methyl, ethyl, n-butyl, n-octyl and 2-ethylhexyl ester, as well as mixtures of these monomers.

Monomers having more than one polymerisable double bond can be copolymerised for crosslinking. Preferred examples of crosslinking monomers are esters of unsaturated monocarboxylic acids having 3 to 8 C atoms and unsaturated monohydric alcohols having 3 to 12 C atoms, or saturated polyols having 2 to 4 OH groups and 2 to 20 C atoms, such as for example ethylene glycol dimethacrylate, allyl methacrylate; polyunsaturated heterocyclic compounds, such as for example trivinyl and triallyl cyanurate; polyfunctional vinyl compounds, such as divinyl and trivinyl benzenes; but also triallyl phosphate and diallyl phthalate.

Preferred crosslinking monomers are allyl methacrylate, ethylene glycol dimethacrylate, diallyl phthalate and heterocyclic compounds having at least three ethylenically unsaturated groups.

Particularly preferred crosslinking monomers are the cyclic monomers triallyl cyanurate, triallyl isocyanurate, trivinyl cyanurate, triacryloyl hexahydro-s-triazine, triallyl benzenes.

The amount of crosslinking monomers is preferably 0.02 to 5.00, in particular 0.05 to 2.00 wt. %, relative to the graft base (a).

In the case of cyclic crosslinking monomers having at least three ethylenically unsaturated groups it may be advantageous to restrict the amount to less than 1 wt. % of the graft base (a).

Preferred “other” polymerisable, ethylenically unsaturated monomers which can optionally serve to produce the graft base (a) in addition to the acrylic acid esters are for example acrylonitrile, styrene, α-methylstyrene, acrylamides, vinyl C₁-C₆ alkyl ethers, methyl methacrylate, butadiene. Preferred acrylate rubbers as the graft base (a) are emulsion polymers having a gel content of at least 60 wt. %.

### Component C

The compositions according to the invention furthermore contain flame retardants, these being preferably selected from the group which includes phosphorus-containing flame retardants and halogenated flame retardants.

Phosphorus-containing flame retardants are particularly preferred, wherein these phosphorus-containing flame retardants are selected from the groups of monomeric and oligomeric phosphates and phosphonates, phosphonate amines, phosphazenes and phosphinic acid salts, wherein mixtures of several components selected from one or more of these groups can also be used as flame retardants. Other halogen-free phosphorus compounds not specifically mentioned here can also be used alone or in any combination with other halogen-free phosphorus compounds.

Preferred monomeric and oligomeric phosphates or phosphonates are phosphorus compounds of the general formula (V)

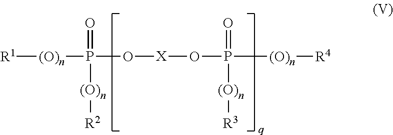

in which
R¹, R², R³ and R⁴ independently of one another denote optionally halogenated C₁ to C₈ alkyl, each optionally substituted with alkyl, preferably C₁ to C₄ alkyl, and/or halogen, preferably chlorine, bromine, substituted C₅ to C₆ cycloalkyl, C₆ to C₂₀ aryl or C₇ to C₁₂ aralkyl,
n independently denotes 0 or 1,
q denotes 0 to 30 and
X denotes a mono- or polynuclear aromatic radical having 6 to 30 C atoms, or a linear or branched aliphatic radical having 2 to 30 C atoms, which can be OH-substituted and can contain up to 8 ether bonds.
R¹, R², R³ and R⁴ preferably independently of one another denote C₁ to C₄ alkyl, phenyl, naphthyl or phenyl C₁-C₄ alkyl. The aromatic groups R¹, R², R³ and R⁴ can in turn be substituted with halogen and/or alkyl groups, preferably chlorine, bromine and/or C₁ to C₄ alkyl. Particularly preferred aryl radicals are cresyl, phenyl, xylenyl, propyl phenyl or butyl phenyl and the corresponding brominated and chlorinated derivatives thereof.
X in formula (V) preferably denotes a mono- or polynuclear aromatic radical having 6 to 30 C atoms. This is preferably derived from diphenols of formula (I).
n in formula (V) can independently be 0 or 1, with n preferably being equal to 1.
q (also in formula VI) denotes whole numbers from 0 to 30, preferably 0 to 20, particularly preferably 0 to 10, in the case of mixtures it denotes average values of 0.8 to 5.0, preferably 1.0 to 3.0, more preferably 1.05 to 2.00 and particularly preferably 1.08 to 1.60.
X particularly preferably denotes

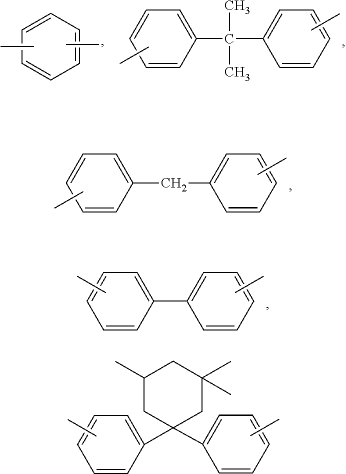

chlorinated or brominated derivatives thereof, in particular X is derived from resorcinol, hydroquinone, bisphenol A or diphenyl phenol. X is particularly preferably derived from bisphenol A.

Phosphorus compounds of formula (V) are in particular tributyl phosphate, triphenyl phosphate, tricresyl phosphate, diphenyl cresyl phosphate, diphenyl octyl phosphate, diphenyl-2-ethyl cresyl phosphate, tri(isopropylphenyl)phosphate, resorcinol-bridged oligophosphate and bisphenol A-bridged oligophosphate. The use of oligomeric phosphate esters of formula (V) derived from bisphenol A is preferred in particular.

Bisphenol A-based oligophosphate according to formula (Va) is most preferred as component C

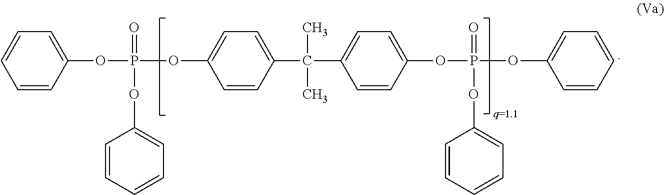

In an alternative preferred embodiment component C is resorcinol-based oligophosphate according to formula (Vb)

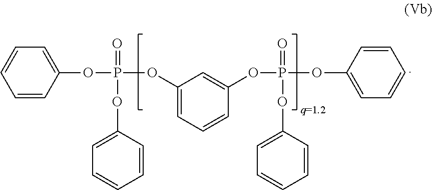

The phosphorus compounds according to component C are known (cf. for example EP-A 0 363 608, EP-A 0 640 655) or can be produced by known methods in an analogous manner (e.g. Ullmanns Enzyklopädie der technischen Chemie, vol. 18, p. 301 ff. 1979; Houben-Weyl. Methoden der organischen Chemie, vol. 12/1, p. 43; Beilstein vol. 6, p. 177).

Mixtures of phosphates with a different chemical structure and/or with the same chemical structure and a different molecular weight can also be used as component C according to the invention. Mixtures with the same structure and a different chain length are preferably used, wherein the specified q value is the average q value. The average q value can be determined by determining the composition of the phosphorus compound (molecular weight distribution) by means of a suitable method (gas chromatography (GC), high-pressure liquid chromatography (HPLC), gel permeation chromatography (GPC)) and using this to calculate the average values for q.

Phosphonate amines and phosphazenes as described in WO 00/00541 and WO 01/18105 can also be used as flame retardants.

The flame retardants can be used alone or in any combination with one another or mixed with other flame retardants.

Other preferred flame retardants within the meaning of the invention are salts of a phosphinic acid with any metal cations. Mixtures of salts which differ in their metal cation can also be used. The metal cations are the cations of metals of the 1^{st} main group (alkali metals, preferably Li⁺, Na⁺, K⁺), the 2^{nd} main group (alkaline-earth metals; preferably Mg²⁺, Ca²⁺, Sr²⁺, Ba²⁺, particularly preferably Ca²⁺) or the 3^{rd} main group (elements of the boron group; preferably Al³⁺) and/or the 2^{nd}, 7^{th} or 8^{th} subgroup (preferably Zn²⁺, Mn²⁺, Fe²⁺, Fe³⁺) of the periodic table.

A salt or a mixture of salts of a phosphinic acid of formula (IV) is preferably used,

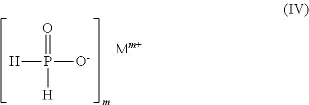

in which M^{m+} is a metal cation of the 1^{st} main group (alkali metals; m=1), 2^{nd} main group (alkaline-earth metals; m=2) or 3^{rd} main group (m=3) or the 2^{nd}, 7^{th} or 8^{th} subgroup (wherein m denotes a whole number from 1 to 6, preferably 1 to 3 and particularly preferably 2 or 3) of the periodic table.

Particularly preferred in formula (IV) are

for m=1 the metal cations M⁺=Li⁺, Na⁺, K⁺,
for m=2 the metal cations M²⁺=Mg²⁺, Ca²⁺, Sr²⁺, Ba²⁺ and
for m=3 the metal cations M³⁺=Al³⁺,
with Ca²⁺ (m=2) and Al³⁺ (m=3) being most preferred.

In a preferred embodiment the average particle size d₅₀ of the phosphinic acid salt (component C) is less than 80 μm, preferably less than 60 μm, with d₅₀ particularly preferably being between 10 μm and 55 μm. The average particle size d₅₀ is the diameter above and below which respectively 50 wt. % of the particles lie. Mixtures of salts which differ in their average particle size d₅₀ can also be used.

These requirements of the particle size are in each case linked to the technical effect whereby the flame retardant efficiency of the phosphinic acid salt is increased.

The phosphinic acid salt can be used either alone or in combination with other phosphorus-containing flame retardants.

### Component D

The compositions according to the invention can preferably contain fluorinated polyolefins D as an antidripping agent. Fluorinated polyolefins are generally known (cf. for example EP-A 640 655). An example of a commercial product is Teflon® 30 N from DuPont.

The fluorinated polyolefins can also be used in the form of a coagulated mixture of emulsions of the fluorinated polyolefins with emulsions of the graft polymers B) or an emulsion of a copolymer E.1), preferably based on styrene/acrylonitrile or polymethyl methacrylate, wherein the fluorinated polyolefin is mixed as an emulsion with an emulsion of the graft polymer or copolymer and then coagulated.

The fluorinated polyolefins can moreover be used as a precompound with the graft polymer B) or a copolymer E.1), preferably based on styrene/acrylonitrile or polymethyl methacrylate. The fluorinated polyolefins are mixed as a powder with a powder or granules of the graft polymer or copolymer and compounded in the melt, generally at temperatures of 200 to 330° C., in conventional units such as internal mixers, extruders or twin-shaft screws.

The fluorinated polyolefins can also be used in the form of a masterbatch, which is produced by emulsion polymerisation of at least one monoethylenically unsaturated monomer in the presence of an aqueous dispersion of the fluorinated polyolefin. Preferred monomer components are styrene, acrylonitrile and mixtures thereof. After acid precipitation and subsequent drying the polymer is used as a free-flowing powder.

The coagulates, precompounds or masterbatches conventionally have solids contents of fluorinated polyolefin of 5 to 95 wt. %, preferably 7 to 60 wt. %.

### Component E

Component E comprises one or more thermoplastic vinyl (co)polymers E.1 and/or polyalkylene terephthalates E.2.

Polymers of at least one monomer from the group of vinyl aromatics, vinyl cyanides (unsaturated nitriles), unsaturated carboxylic acids and derivatives (such as esters, anhydrides and imides) of unsaturated carboxylic acids are suitable as vinyl (co)polymers E.1. Particularly suitable are (co)polymers of
E.1.1 50 to 99, preferably 60 to 80 parts by weight of vinyl aromatics and/or ring-substituted vinyl aromatics (such as styrene, α-methylstyrene, p-methylstyrene, p-chlorostyrene), and
E.1.2 1 to 50, preferably 20 to 40 parts by weight of vinyl cyanides (unsaturated nitriles, such as acrylonitrile and methacrylonitrile) and/or unsaturated carboxylic acids (such as acrylic acid and maleic acid) and/or derivatives (such as anhydrides and imides) of unsaturated carboxylic acids (for example maleic anhydride and N-phenyl maleinimide).

The vinyl (co)polymers E.1 are resin-like, thermoplastic and rubber-free. The copolymer of E.1.1 styrene and E.1.2 acrylonitrile is particularly preferred.

The (co)polymers according to E.1 are known and can be produced by radical polymerisation, in particular by emulsion, suspension, solution or bulk polymerisation. The (co)polymers preferably have average molecular weights Mw (weight-average, determined by light scattering or sedimentation) of between 15,000 and 200,000.

The polyalkylene terephthalates of component E.2 are reaction products of aromatic dicarboxylic acids or reactive derivatives thereof, such as dimethyl esters or anhydrides, and aliphatic, cycloaliphatic or araliphatic diols and mixtures of these reaction products. Preferred polyalkylene terephthalates contain at least 80 wt. %, preferably at least 90 wt. %, relative to the dicarboxylic acid component, of terephthalic acid radicals and at least 80 wt. %, preferably at least 90 mol %, relative to the diol component, of ethylene glycol and/or butanediol-1,4 radicals.

The preferred polyalkylene terephthalates can contain in addition to terephthalic acid esters up to 20 mol %, preferably up to 10 mol %, of radicals of other aromatic or cycloaliphatic dicarboxylic acids having 8 to 14 C atoms or aliphatic dicarboxylic acids having 4 to 12 C atoms, such as for example radicals of phthalic acid, isophthalic acid, naphthalene-2,6-dicarboxylic acid, 4,4′-diphenyl dicarboxylic acid, succinic acid, adipic acid, sebacic acid, azelaic acid, cyclohexane diacetic acid.

The preferred polyalkylene terephthalates can contain, in addition to ethylene glycol or butanediol-1,4 radicals, up to 20 mol %, preferably up to 10 mol %, of other aliphatic diols having 3 to 12 C atoms or cycloaliphatic diols having 6 to 21 C atoms, for example radicals of propanediol-1,3,2-ethyl propanediol-1,3, neopentyl glycol, pentanediol-1,5, hexanediol-1,6, cyclohexane dimethanol-1,4,3-ethyl pentanediol-2,4,2-methyl pentanediol-2,4,2,2,4-trimethyl pentanediol-1,3,2-ethyl hexanediol-1,3,2,2-diethyl propanediol-1,3, hexanediol-2,5,1,4-di-(β-hydroxyethoxy)benzene, 2,2-bis-(4-hydroxycyclohexyl)propane, 2,4-dihydroxy-1,1,3,3-tetramethylcyclobutane, 2,2-bis-(4-β-hydroxyethoxyphenyl)propane and 2,2-bis-(4-hydroxypropoxyphenyl)propane (DE-A 2 407 674, 2 407 776, 2 715 932).

The polyalkylene terephthalates can be branched by the incorporation of relatively small amounts of trihydric or tetrahydric alcohols or tribasic or tetrabasic carboxylic acids, as described for example in DE-A 1 900 270 and U.S. Pat. No. 3,692,744. Examples of preferred branching agents are trimesic acid, trimellitic acid, trimethylolethane, trimethylolpropane and pentaerythritol.

Polyalkylene terephthalates produced solely from terephthalic acid and reactive derivatives thereof (for example dialkyl esters thereof) and ethylene glycol and/or butanediol-1,4, and mixtures of these polyalkylene terephthalates, are particularly preferred.

Mixtures of polyalkylene terephthalates contain 1 to 50 wt. %, preferably 1 to 30 wt. %, of polyethylene terephthalate and 50 to 99 wt. %, preferably 70 to 99 wt. %, of polybutylene terephthalate.

The polyalkylene terephthalates that are preferably used generally have an intrinsic viscosity of 0.4 to 1.5 dl/g, preferably 0.5 to 1.2 dl/g, measured in phenol/o-dichlorobenzene (1:1 parts by weight) at 25° C. in an Ubbelohde viscometer.

The polyalkylene terephthalates can be produced by known methods (see for example Kunststoff-Handbuch, volume VIII, p. 695 ff., Carl-Hanser-Verlag, Munich 1973).

### Further Additives F

The moulding compositions according to the invention can optionally contain at least one further of the conventional additives, such as for example lubricants and release agents, nucleating agents, antistatics, stabilisers, dyes and pigments as well as fillers and reinforcing agents.

Component F also comprises extremely fine-particle inorganic compounds having an average particle diameter of less than or equal to 200 nm, preferably less than or equal to 150 nm, in particular 1 to 100 nm. Suitable extremely fine-particle inorganic compounds preferably consist of at least one polar compound of one or more metals of the 1^{st} to 5^{th} main group or 1^{st} to 8^{th} subgroup of the periodic table, preferably the 2^{nd} to 5^{th} main group or 4^{th} to 8^{th} subgroup, particularly preferably the 3^{rd} to 5^{th} main group or 4^{th} to 8^{th} subgroup, or of compounds of these metals with at least one element selected from oxygen, hydrogen, sulfur, phosphorus, boron, carbon, nitrogen or silicon. Preferred compounds are for example oxides, hydroxides, hydrous oxides, sulfates, sulfites, sulfides, carbonates, carbides, nitrates, nitrites, nitrides, borates, silicates, phosphates, hydrides, phosphites or phosphonates. The extremely fine-particle inorganic compounds preferably consist of oxides, phosphates, hydroxides, preferably TiO₂, SiO₂, SnO₂, ZnO, ZnS, boehmite, ZrO₂, Al₂O₃, aluminium phosphates, iron oxides, also TiN, WC, AlO(OH), Fe₂O₃ iron oxides, NaSO₄, vanadium oxides, zinc borate, silicates such as Al silicates, Mg silicates, one-, two-, three-dimensional silicates and talc. Mixtures and doped compounds can likewise be used. These extremely fine-particle inorganic compounds can furthermore be surface-modified with organic molecules in order to achieve a better compatibility with the polymers. Hydrophobic or hydrophilic surfaces can be produced in this way. Hydrate-containing aluminium oxides (e.g. boehmite) or TiO₂ are particularly preferred.

Particle size and particle diameter of the inorganic particles denote the average particle diameter d₅₀, determined for example by sedimentation measurements via the sedimentation rate of the particles in a SediGraph, for example.

The inorganic compounds can take the form of powders, pastes, sols, dispersions or suspensions. Powders can be obtained from dispersions, sols or suspensions by precipitation.

The inorganic compounds can be incorporated into the thermoplastic moulding compositions by conventional methods, for example by direct compounding or extrusion of moulding compositions and the extremely fine-particle inorganic compounds. Preferred methods are the production of a masterbatch, for example in flame retardant additives and at least one component of the moulding compositions according to the invention in monomers or solvents, or the coprecipitation of a thermoplastic component and the extremely fine-particle inorganic compounds, for example by coprecipitation of an aqueous emulsion and the extremely fine-particle inorganic compounds, optionally in the form of dispersions, suspensions, pastes or sols of the extremely fine-particle inorganic materials.

The compositions according to the present inventions are produced by mixing the individual constituents in a known manner and melt-compounding and melt-extruding them at temperatures of 200° C. to 300° C. in conventional units such as internal mixers, extruders and twin-shaft screws. Mixing of the individual constituents can take place in a known manner either successively or simultaneously and both at around 20° C. (room temperature) and at elevated temperature.

By virtue of their outstanding balance of good impact resistance at low temperatures combined with high weld line strength as well as good flame resistance and excellent chemical resistance, the thermoplastic compositions and moulding compositions according to the present invention are suitable for producing battery boxes according to the invention.

The invention likewise provides processes for producing the battery boxes and the use of the moulding compositions for the production of battery boxes. The moulding compositions can be processed to form battery boxes by means of injection moulding. The invention also provides the production of battery boxes by thermoforming from prefabricated sheets or films.

The battery boxes are suitable for any application, for example, the following applications: vehicle batteries and rechargeable batteries, battery boxes for motor vehicles, buses, lorries, caravans, rail vehicles, aircraft, watercraft or other vehicles, static batteries, for example in buildings for an emergency power supply or for the storage of solar energy from photovoltaic installations. The battery boxes preferably should be designed to meet the requirements of the UN 3480 transport test.

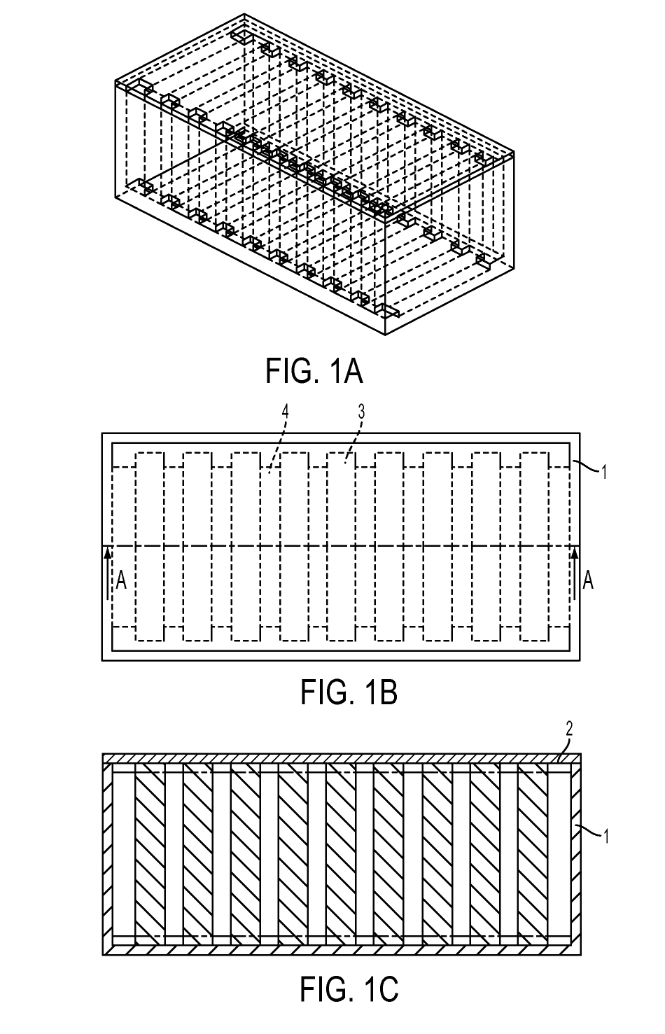

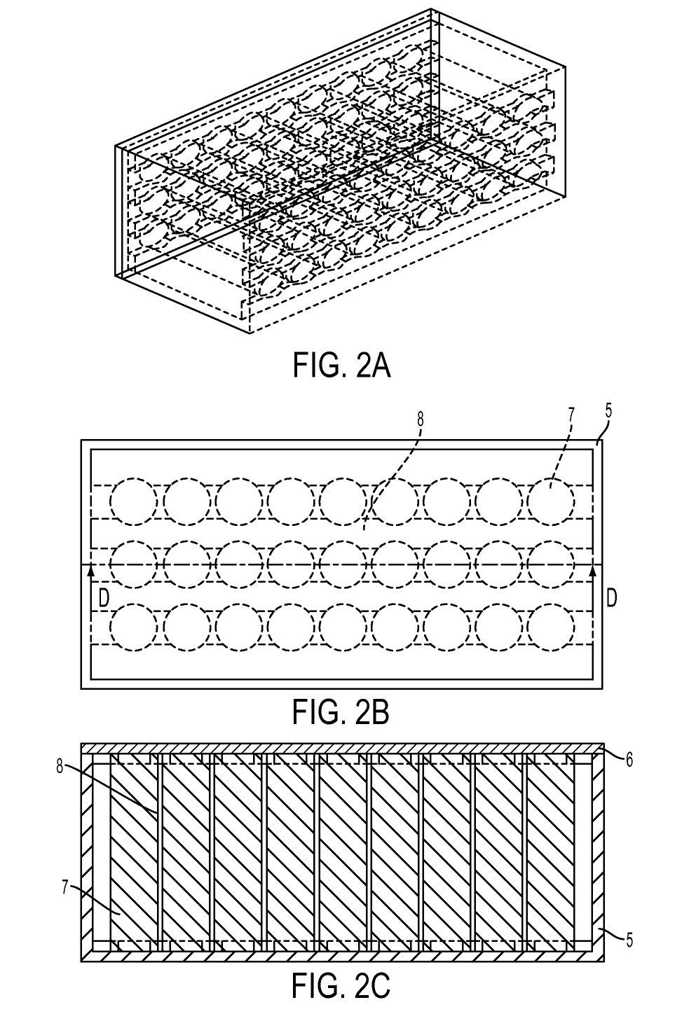

Examples of battery boxes according to the invention are illustrated in FIGS. 1 and 2.

FIG. 1A shows a battery box for flat battery cells with a gap between the insertion slots for the flat cells, in which a coolant can be placed or in which a coolant circulates.

FIG. 1B shows a top view of the battery box for flat battery cells.

FIG. 1C shows a cross-sectional view (cross-section AA) through the battery box for flat battery cells.

FIG. 2A shows a battery box for cylindrical battery cells with a gap between the insertion slots for the cylindrical cells, in which a coolant can be placed or in which a coolant circulates.

FIG. 2B shows a top view of the battery box for cylindrical battery cells.

FIG. 2C shows a cross-sectional view (cross-section DD) through the battery box for cylindrical battery cells.

The references in the figures have the following meaning:
1, 5=box
2, 6=cover
3, 7=insertion slot for flat cell (FIG. 1) or cylindrical cell (FIG. 2)
4, 8=gap between cells for cooling medium

In a preferred embodiment, the battery box has channels for cooling the individual cells, preferably water/glycol cooling or air cooling.

In an alternative embodiment the battery box consists of an outer box and an inner insert to hold the individual cells, wherein the outer box can optionally be insulated, for example by means of a double wall. The outer box and the cell holder (insertion slots) are preferably manufactured from a single material and more preferably from a single component (one-piece construction).

Several battery boxes can preferably be expanded in a modular manner to obtain larger units.

In a further preferred embodiment, the battery box contains a holder for electronic controls.

The examples below serve to further clarify the invention.

### EXAMPLES

### Component A-1

Linear polycarbonate based on bisphenol A with a relative solution viscosity of ηᵣₑₗ=1.28 measured in CH₂Cl₂ as solvent at 25° C. and at a concentration of 0.5 g/100 ml.

### Component B:

ABS polymer produced by emulsion polymerisation of 43 wt. % (relative to the ABS polymer) of a mixture of 27 wt. % acrylonitrile and 73 wt. % styrene in the presence of 57 wt. % (relative to the ABS polymer) of a particulate crosslinked polybutadiene rubber (average particle diameter d₅₀=0.35 μm), wherein the graft polymer contains approximately 15% free, soluble SAN. The gel content is 72%.

### Component C:

Bisphenol A-based oligophosphate (Reofoss BAPP) according to formula (Va)

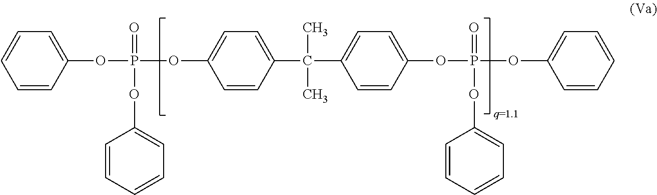

### Component D:

Polytetrafluoroethylene powder, CFP 6000 N, Du Pont.

### Component F:

F-1: Pentaerythritol tetrastearate as lubricant/release agent

F-2: Phosphite stabiliser, Irganox® B900 (mixture of 80% Irgafos® 168 and 20% Irganox® 1076; BASF AG; Ludwigshafen/Irgafos® 168 (tris(2,4-di-tert-butylphenyl)phosphite)/Irganox® 1076 (2,6-di-tert-butyl-4-(octadecanoxycarbonylethyl)phenol).

The materials listed in Table 1 are compounded and granulated in a twin-screw extruder (ZSK-25) (Werner & Pfleiderer) at a speed of 225 rpm and a throughput of 20 kg/h at a machine temperature of 260° C. The finished granules are processed in an injection moulding machine to form the corresponding test pieces (composition temperature 240° C., mould temperature 80° C., melt front velocity 240 mm/s).

The following methods were used to characterise the properties of the test pieces:

The flowability was determined in accordance with ISO 11443 (melt viscosity).

The notched impact resistance ak was measured in accordance with ISO 180/1A on a specimen injection-moulded on one side and measuring 80×10×4 mm, at the specified measuring temperatures.

The heat resistance was measured in accordance with DIN ISO 306 (Vicat softening temperature, method B, with a 50 N load and at a heating rate of 120 K/h) on a specimen injection-moulded on one side and measuring 80×10×4 mm.

The fire behaviour is measured in accordance with UL 94V on specimens measuring 127×12.7×1.5 mm.

The ultimate elongation and tensile modulus of elasticity were measured in accordance with DIN EN ISO 527 on specimens measuring 170.0×10.0×4.0 mm.

Under chemical resistance (ESC behaviour), the time to fracture at 2.4% outer fibre strain following storage of the test piece in the given test substances at room temperature is stated for a specimen injection-moulded on one side and measuring 80×10×4 mm.

TABLE
Compositions and their properties

wt. %

| Components | 1 | 2 |
|---|---|---|
| A1 | 84.10 | 78.10 |
| B | 9.00 | 11.00 |
| C | 6.00 | 10.00 |
| D | 0.40 | 0.40 |
| F-1 | 0.40 | 0.40 |
| F-2 | 0.10 | 0.10 |
| Total | 100.00 | 100.00 |

| Properties | units | | |
|---|---|---|---|
| ak ISO 180/1A at RT | [kJ/m²] | 52 | 57 |
| ak ISO 180/1A at −20° C. | [kJ/m²] | 34 | 33 |
| ak ISO 180/1A at −40° C. | [kJ/m²] | 18 | 17 |
| Weld line | [kJ/m²] | 74 | 73 |
| Vicat B 120 | [° C.] | 120 | 110 |
| UL 94 V/1.5 mm | | V-1 | V-1 |
| Burning time | [s] | 54 | 50 |
| UL 94 V/2.5 mm | | V-0 | V-0 |
| Burning time | [s] | 15 | 11 |
| Melt viscosity | | | |
| 260° C./1000 s−1 | [Pas] | 415 | 319 |
| ESC at 2.4%, toluene/isopropanol (60:40) | h:min | 2:42 | 4:01 |
| ESC at 2.4%, rapeseed oil | h:min | 3:57 | 2:05 |
| ESC at 2.4%, glycol/water (50:50) | h:min | 108:00 | 149:00 |
| ESC at 2.4%, hydraulic oil | h:min | 168:00 | 168:00 |
| Ultimate elongation | % | | |
| Tensile modulus of elasticity | N/mm² | 2340 | 2350 |

Mixture of toluene/isopropanol: 60/40 wt. %

1. Battery box comprising a composition comprising
A) 70.0 to 90.0 parts by weight, relative to the sum of parts by weight of components A+B+C, of at least one linear and/or branched aromatic polycarbonate and/or aromatic polyester carbonate,
B) 6.0 to 15.0 parts by weight, relative to the sum of parts by weight of components A+B+C, of at least one graft polymer with
B.1) 5 to 95 parts by weight of a mixture of
B.1.1) 50 to 95 parts by weight of styrene, α-methylstyrene, methyl ring-substituted styrene, C₁-C₈ alkyl methacrylate, C₁-C₈ alkyl acrylate, and/or a mixture thereof, and
B.1.2) 5 to 50 parts by weight of acrylonitrile, methacrylonitrile, C₁-C₈ alkyl methacrylates, in particular methyl methacrylate, C₁-C₈ alkyl acrylate, maleic anhydride, C₁-C₄ alkyl or phenyl N-substituted maleinimides and/or a mixtures thereof, on
B.2) 5 to 95 parts by weight of a rubber-containing graft base based on butadiene or acrylate,
C) 2.0 to 15.0 parts by weight, relative to the sum of parts by weight of components A+B+C, of one or more phosphorus compounds selected from the group consisting of monomeric and oligomeric phosphates and phosphonates, phosphonate amines, phosphazenes and phosphinates,
D) 0 to 3.0 parts by weight, relative to the sum of parts by weight of components A+B+C, of one or more antidripping agents,
E) 0 to 3.0 parts by weight, relative to the sum of parts by weight of components A+B+C, of thermoplastic vinyl (co)polymer (E.1) and/or polyalkylene terephthalate (E.2), and
F) 0 to 20.0 parts by weight, relative to the sum of parts by weight of components A+B+C, of one or more further additives,
wherein the compositions are optionally free from rubber-free polyalkyl(alkyl)acrylate and wherein all stated parts by weight are standardised such that the sum of parts by weight of components A+B+C in the composition is 100.

2. Battery box according to claim 1, wherein component C comprises one or more phosphorus compounds according to formula (VI), 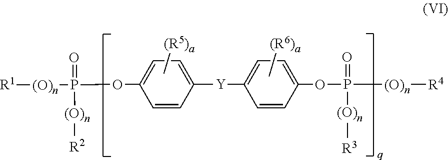
in which
R¹, R², R³ and R⁴ independently of each other denote C₁-C₈ alkyl, optionally substituted with halogen, C₅-C₆ cycloalkyl, C₆-C₁₀ aryl or C₇-C₁₂ aralkyl, each optionally substituted with halogen and/or alkyl,
n independently denotes 0 or 1,
a independently denotes 0, 1, 2, 3 or 4,
q denotes 0 to 30
R⁵ and R⁶ independently of each other denote C₁-C₄ alkyl, preferably methyl, or halogen,
and
Y denotes C₁-C₇ alkylidene, C₁-C₇ alkylene, C₅-C₁₂ cycloalkylene, C₅-C₁₂ cycloalkylidene, —O—, —S—, —SO—, —SO₂— or —CO—.

3. Battery box according to claim 1, comprising 9.0 to 11.0 parts by weight, relative to the sum of components A+B+C, of component B.

4. Battery box according to claim 1, comprising 4.0 to 11.0 parts by weight, relative to the sum of components A+B+C, of component C.

5. Battery box according to claim 2, comprising as component C a mixture of a monophosphate and an oligophosphate according to formula (VI), wherein the average value of q is 1.06 to 1.15.

6. Battery box according to claim 1, comprising 0.1 to 0.6 parts by weight, relative to the sum of components A+B+C, of component D.

7. Battery box according to claim 1, wherein component F is included and comprises at least one additive selected from the group consisting of lubricants and release agents, nucleating agents, antistatics, stabilisers, dyes, pigments, fillers, reinforcing agents and extremely fine-particle inorganic compounds, wherein the extremely fine-particle inorganic compounds have an average particle diameter of less than or equal to 200 nm.

8. Battery box according to claim 1, wherein the battery box has an outer box and an inner insert to hold individual cells.

9. Battery box according to claim 1, comprising channels for cooling individual cells.

10. A composition capable of being formed into a battery box, said composition comprising
A) 70.0 to 90.0 parts by weight, relative to the sum of parts by weight of components A+B+C, of linear and/or branched aromatic polycarbonate and/or aromatic polyester carbonate,
B) 6.0 to 15.0 parts by weight, relative to the sum of parts by weight of components A+B+C, of at least one graft polymer with
B.1) 5 to 95, parts by weight of a mixture of
B.1.1) 50 to 95 parts by weight of at least one of styrene, α-methylstyrene, methyl ring-substituted styrene, C₁-C₈ alkyl methacrylate, and/or C₁-C₈ alkyl acrylate, and
B.1.2) 5 to 50 parts by weight of at least one of acrylonitrile, methacrylonitrile, C₁-C₈ alkyl methacrylates, C₁-C₈ alkyl acrylate, maleic anhydride, C₁-C₄ alkyl and/or phenyl N-substituted maleinimides, on
B.2) 5 to 95, parts by weight of a rubber-containing graft base based on butadiene or acrylate,
C) 2.0 to 15.0 parts by weight, relative to the sum of parts by weight of components A+B+C, of one or more phosphorus compounds selected from the group consisting of monomeric and oligomeric phosphates and phosphonates, phosphonate amines, phosphazenes and phosphinates,
D) 0 to 3.0 parts by weight, relative to the sum of parts by weight of components A+B+C, of one or more antidripping agents,
E) 0 to 3.0 parts by weight, relative to the sum of parts by weight of components A+B+C, of thermoplastic vinyl (co)polymer (E.1) and/or polyalkylene terephthalate (E.2), and
F) 0 to 20.0 parts by weight, relative to the sum of parts by weight of components A+B C, of one or more further additives,
wherein the compositions are optionally free from rubber-free polyalkyl(alkyl)acrylate and wherein all stated parts by weight are standardised such that the sum of parts by weight of components A+B+C in the composition is 100.

11. A composition according to claim 10, wherein component C is selected from phosphorus compounds according to formula (VI), 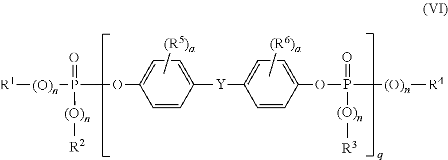
in which
R¹, R², R³ and R⁴ independently of each other denote C₁-C₈ alkyl, optionally substituted with halogen, C₅-C₆ cycloalkyl, C₆-C₁₀ aryl or C₇-C₁₂ aralkyl, each optionally substituted with halogen and/or alkyl,
n independently denotes 0 or 1,
a independently denotes 0, 1, 2, 3 or 4,
q denotes 0 to 30
R⁵ and R⁶ independently of each other denote C₁-C₄ alkyl, preferably methyl, or halogen, and
Y denotes C₁-C₇ alkylidene, C₁-C₇ alkylene, C₅-C₁₂ cycloalkylene, C₅-C₁₂ cycloalkylidene, —O—, —S—, —SO—, —SO₂— or —CO—.

12. A composition according to claim 10, comprising 9.0 to 11.0 parts by weight, relative to the sum of components A+B+C, of component B.

13. A composition according to claim 10, comprising 4.0 to 11.0 parts by weight, relative to the sum of components A+B+C, of component C.

14. A composition according to claim 10, comprising 0.1 to 0.6 parts by weight, relative to the sum of components A+B+C, of component D.

15. Process for producing a battery box according to claim 1 comprising injection molding and/or thermoforming said composition until said composition is moulded and/or thermoformed.

16. A composition of claim 10, wherein D) is present in an amount of 0.01 to 1.00 parts by weight and F) is present in an amount of 0.1 to 10.0 parts by weight, all relative to the sum of parts by weight of components A+B+C.

17. A battery box of claim 1, wherein D) is present in an amount of 0.01 to 1.00 parts by weight and F) is present in an amount of 0.1 to 10.0 parts by weight, all relative to the sum of parts by weight of components A+B+C.
